(19) United States
(12) Patent Application Publication
(10) Pub. No.: US 2016/0021254 A1
(43) Pub. Date: Jan. 21, 2016

(54) METHODS, SYSTEMS, AND APPARATUS FOR CONDUCTING A CONFERENCE SESSION

(71) Applicants: Kenny Red, Omaha, NE (US); Thad R. Lyon, San Jose, CA (US)

(72) Inventors: Kenny Red, Omaha, NE (US); Thad R. Lyon, San Jose, CA (US)

(21) Appl. No.: 14/588,236

(22) Filed: Dec. 31, 2014

Related U.S. Application Data
(60) Provisional application No. 62/024,862, filed on Jul. 15, 2014.

(51) Int. Cl. H04M 3/56

(52) U.S. Cl. CPC H04M 3/565

(57) ABSTRACT

Methods, systems, apparatus, and articles of manufacture for initiating and conducting a conference call are described. Identification information of a user is obtained, and an electronic mail address and/or user name of the user is determined based on the identification information. At least a first portion of an online calendar of the user is accessed based on the electronic mail address or user name, and at least a second portion of the online calendar is parsed to identify one or more scheduled conference sessions. One or more of the scheduled conference sessions are presented to the user, and a user selection of one of the scheduled conference sessions is obtained. A conference session is established based on the user selection of the scheduled conference session.

### PRIORITY

This patent application is a non-provisional of and claims the benefit of priority, to U.S. Provisional Patent Application Ser. No. 62/024,862, filed Jul. 15, 2014, which is incorporated herein by reference in its entirety.

### TECHNICAL FIELD

The present application relates generally to electronic communications and, more specifically, in one example, to conducting a conference call.

### BACKGROUND

A conference call is a common method for enabling communications between participants of a geographically distributed meeting. Each conference call may have two or more participants located at two or more geographically separated locations. The conference call may allow each participant to send and/or receive communications in the form of video, still images, graphics, audio, speech, text, and the like. In some cases, participants may conduct the conference call at a location where equipment that supports the desired means of communications is located and/or at a location large enough to support the number of participants. For example, the participants may secure a number of conference rooms that are both suitable for conducting the conference call and for the number of participants at each corresponding location. In some cases, the conference room and/or the conference call equipment may be reserved in advance. In other cases, the conference room and/or the conference call equipment may need to be acquired at or near the time of the conference call.

### BRIEF DESCRIPTION OF THE DRAWINGS

Some embodiments are illustrated by way of example and not limitation in the figures of the accompanying drawings in which:

FIG. 1 is a block diagram of an example conferencing system for initiating, conducting, and terminating a conference call, in accordance with an example embodiment;

FIGS. 2A and 2B are an example workflow for initiating, conducting, and terminating a conference call, in accordance with an example embodiment;

FIG. 3 is a block diagram of an example apparatus for initiating, conducting, and terminating a conference call, in accordance with an example embodiment;

FIG. 4 is a representation of an example user interface for initiating, conducting, and terminating a conference call, in accordance with an example embodiment;

FIG. 5 is a flowchart for an example method for initiating, conducting, and terminating a conference call session, in accordance with an example embodiment;

FIG. 6 is a block diagram illustrating a mobile device, according to an example embodiment; and

FIG. 7 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments and serve to illustrate how the invention may be applied to various purposes or embodiments. Other embodiments of the invention exist and are within the scope of the invention, and logical, mechanical, electrical, and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, methods, systems, apparatus, and articles of manufacture for initiating, conducting, and terminating a conference session are described. As used herein, a “conference session” or “conference call” establishes communication between two or more participants. The conference call may allow each participant to send and/or receive communications in the form of video, still images, graphics, audio, speech, text, and the like.

In one example embodiment, a user may initiate a conference call using a personal identifier. The personal identifier may comprise information, such as a personal identification number, and may be stored on a personal device, such as an employee identification badge, a personal electronic device, and the like. The personal device, such as the employee identification badge, may contain information on, for example, a magnetic strip, a radio frequency identification (RFID) tag, and the like. In one example embodiment, the personal identifier may be used to locate a scheduled conference session and to initiate the conference call.

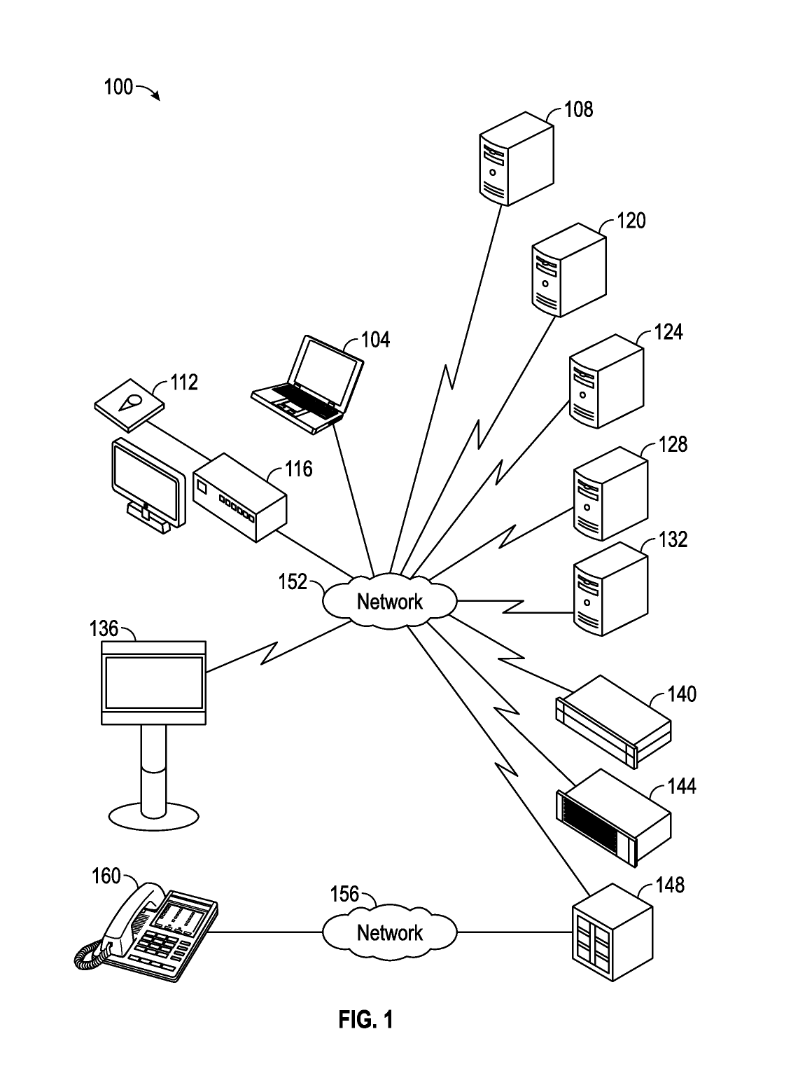

FIG. 1 is a block diagram of an example conferencing system 100 for initiating, conducting, and terminating a conference call, in accordance with an example embodiment. In one example embodiment, the conferencing system 100 may include one or more user devices 104, a signature generation web server 108, a card reader 112, a conference processor 116, one or more mail servers 120, a calendar lookup server 124, an instant video conferencing (IVC) server 128, a security database 132, a conferencing device 136, a virtual meeting room (VMR) management server 140, a multipoint control unit (MCU) server 144, a telecommunications private branch exchange (PBX) 148, a network 152, a telecommunications network 156, and a user telecommunications device 160.

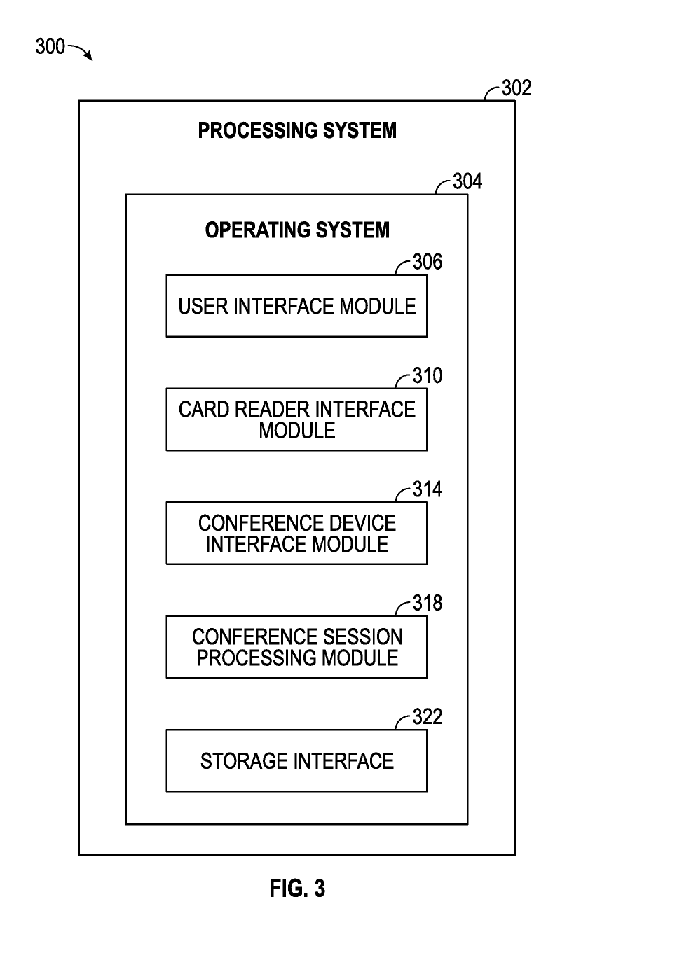

Each user device 104 may be a conferencing station, a personal computer (PC), a tablet computer, a mobile phone, a personal digital assistant (PDA), a wearable computing device (e.g., a smartwatch), or any other appropriate computer device. Each user device 104 may include a user interface module, described more fully below in conjunction with FIG. 3. In one example embodiment, the user interface module may include a web browser program and/or an application, such as a mobile application or a conferencing application. Each user device 104 may enable a user to initiate, conduct, and terminate a conference call. The user device 104 may also enable a user to submit a personal conference signature request to the signature generation web server 108 and to send an invitation to other participants of the conference meeting.

The signature generation web server 108 enables a user to generate a personal conference signature (PCS) for use in identifying and/or authenticating the user prior to initiating and conducting a conference call.

The card reader 112 enables a user to access a scheduled conference call and/or initiate an unscheduled conference call. For example, the card reader 112 may enable a user to swipe an employee badge in order to read, for example, employee information and identify and/or authenticate the user. The user's identity may be used to access a calendar of the user and to locate a scheduled conference call in the user's calendar.

The conference processor 116 processes input from the card reader 112 and enables a user to select a scheduled conference call and/or initiate an unscheduled conference call. The conference processor 116 may submit user identification information to the calendar lookup server 124 to obtain access to the user's online calendar. The conference processor 116 may scan the calendar entries of the user in search of meetings containing conference information. For example, a custom script of the conference processor 116 may search for a conference code in the body of each calendar entry. The conference processor 116 may present relevant scheduled conference sessions to a user. For example, conference sessions scheduled during the next few hours may be presented to the user.

Each mail server 120 provides electronic mail and calendar services to a user. For example, a mail server 120 may store a user's online calendar; the online calendar may comprise scheduled conference meetings and associated conference sessions.

The calendar lookup server 124 provides a calendar lookup based, for example, on a user name, an electronic mail address of a user, and the like. The calendar lookup server 124 may obtain the identified calendar from the mail server 120 and may provide the user's online calendar or one or more entries of the user's online calendar to the conference processor 116. The calendar lookup server 124 may provide to the conference processor 116 only entries from the user's online calendar that are within a predefined range of the current time.

The IVC server 128 may process a request for information for accessing the user's online calendar. For example, the IVC server 128 may match a radio frequency (RF) code (associated with a user) to a user name and/or an electronic mail address. The IVC server 128 may interact with the security database 132 to authenticate the user and determine information used for accessing the user's online calendar.

The security database 132 provides authentication services for authenticating a user in the process of, for example, initiating a conference call. The security database 132 may interact with the IVC server 128 to obtain the information used to access the user's online calendar.

The conferencing device 136 provides a conferencing facility for viewing and/or capturing content such as audio, still images, video, text, graphics, and the like. The conferencing device 136 may be located, for example, in a conference room used by participants of the conference call. The conferencing device 136 may forward instructions for the conference call session to a media application executing on the VMR management server 140 and may exchange content related to the conference meeting with the MCU server 144.

The VMR management server 140 manages a conference session and establishes a conference call on the MCU server 144. Each conference session may be associated with a video conference bridge identifier and may be set up online via, for example, a website host. The virtual meeting allows participants who are geographically distributed to meet and share information in real time. Once the virtual meeting room is set up, the bridging facility will be readily available to participants of the virtual meeting.

The MCU server 144 is used to bridge videoconferencing connections and provides for the exchange of content between the user devices 104 and/or user telecommunications devices 160 participating in each conference call. In one example embodiment, the MCU server 144 comprises a plurality of blades that provide communications between the participating user devices 104 and/or the participating user telecommunications devices 160. Each blade of the MCU server 144 may serve as a server with a dedicated task, such as streaming audio, streaming video, and the like, and may comprise a port for each connection of the bridge.

The telecommunications PBX 148 provides communications between the one or more user telecommunications devices 160 and, for example, an established conference call. The telecommunications PBX 148 may, for example, host a voice bridge to provide communications between the one or more user telecommunications devices 160 and a conference call. The user telecommunications device 160 enables a user(s) to participate in a conference call via the telecommunications PBX 148.

The network 152 and the telecommunications network 156 may each be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, a network of interconnected networks, a combination of two or more such networks, and the like.

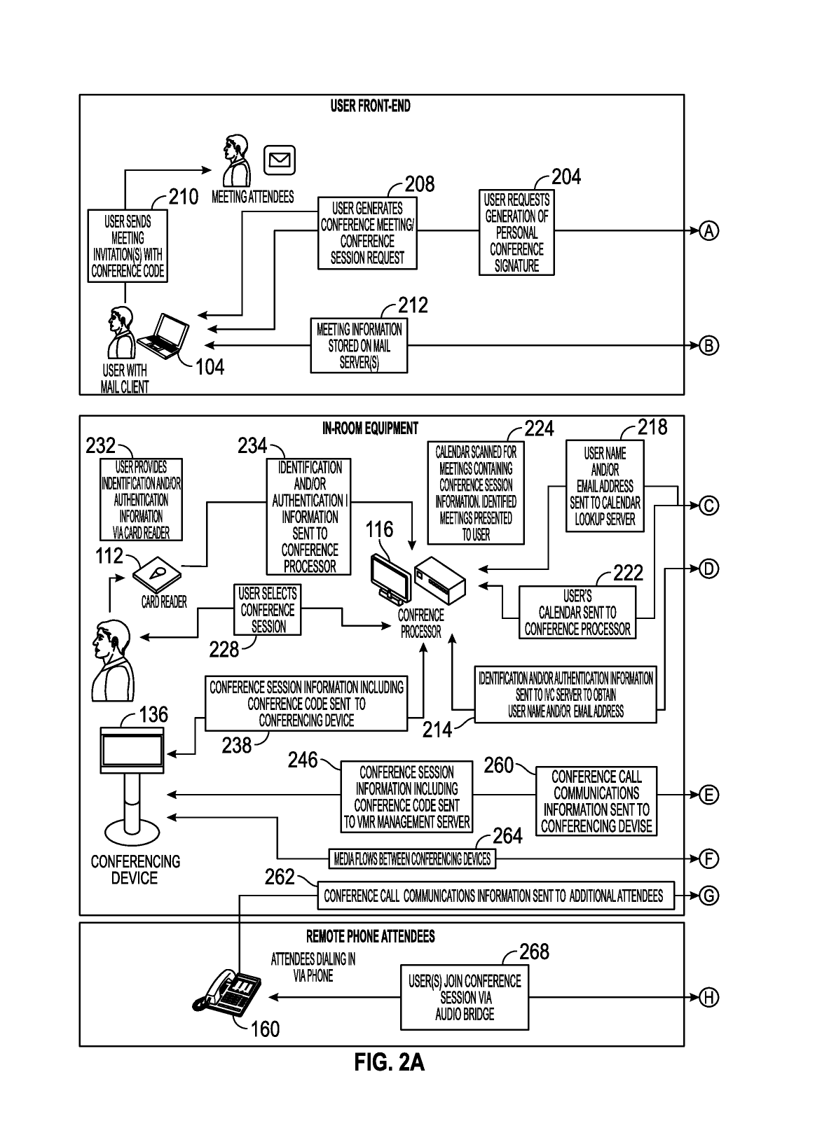

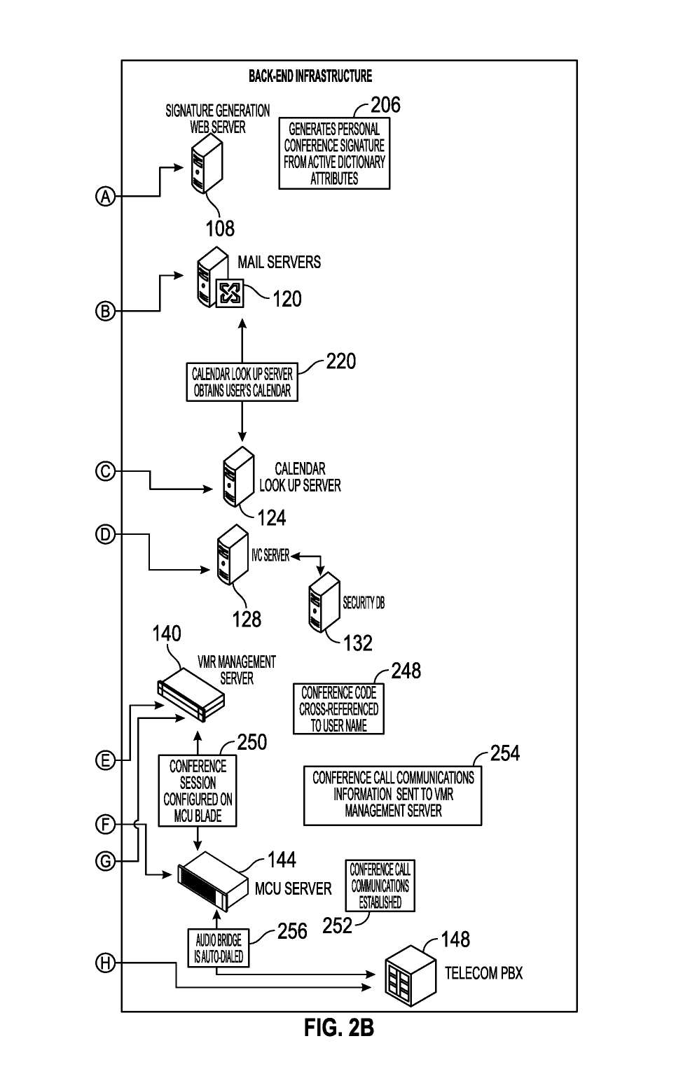

FIGS. 2A and 2B are an example workflow for initiating, conducting, and terminating a conference call, in accordance with an example embodiment. In one example embodiment, a conference meeting setup may be performed to schedule a conference meeting and the associated conference call (operations 204 through 210). Initially, a user may generate a personal conference signature (operation 204) by, for example, submitting a personal conference signature request from the user device 104 to the signature generation web server 108. The personal conference signature may be, for example, an IVC signature. The signature generation web server 108 may generate the personal conference signature based on active dictionary (AD) attributes (operation 206). (An active dictionary is a directory service that authenticates users and devices in a networked environment.) The personal conference signature may be used, for example, to schedule a conference session for the conference meeting and generate calendar invitations for the participants of the conference meeting and the associated conference call.

The user may generate a conference meeting request comprising, for example, a request for a conference session (operation 208). The meeting request may be composed in a calendar application and may include, for example, a conference code (e.g., the IVC code) in the body of the calendar entry to facilitate the establishment of the conference call. The meeting request may be sent to one or more of the conference meeting participants (operation 210). For example, the meeting request may be sent via an online calendar application or another electronic communication system to the meeting attendees. The scheduled conference meeting and associated conference session may be stored on the mail server 120 (operation 212).

In one example embodiment, in order to establish the conference call, a user may present identification and/or authentication information to the conference processor 116 (operation 232). A user may, for example, swipe an employee badge on the card reader 112 to present the user identification and/or authentication information. The identification information may comprise, for example, an RFID code. In one example embodiment, a user may use biometrics (e.g., a fingerprint), information (e.g., a password), a device (e.g., an RFID tag) and the like to present the user identification and/or authentication information. The card reader 112 may then submit the identification information (e.g., the RFID code) to the conference processor 116 (operation 234).

The conference processor 116 may submit the identification information to the IVC server 128 and/or the security database 132 (operation 214) to obtain information for accessing the user's online calendar. For example, the IVC server 128 or the security database 132 may match the RFID code to a user name and/or an electronic mail address. The IVC server 128 may also interact with the security database 132 to authenticate the user and determine the information for accessing the user's online calendar.

The conference processor 116 may submit the user name and/or the electronic mail address to the calendar lookup server 124 to obtain the user's online calendar (operation 218). The calendar lookup server 124 may interact with the mail server 120 to obtain the user's calendar stored on the mail server 120 (operation 220) and may provide the online calendar, including the conference code(s) associated with the scheduled conference session(s), or one or more calendar entries, including the conference code(s) associated with the scheduled conference call session(s), to the conference processor 116 (operation 222).

The conference processor 116 may then scan one or more of the user's calendar entries for meetings containing conference information (operation 224). For example, a custom script of the conference processor 116 may search for a conference code in the body of each calendar entry. The conference processor 116 may limit the search to a particular time period. For example, the conference processor 116 may limit the search to 30 minutes prior to and 90 minutes in the future of the present time. The conference processor 116 may present relevant scheduled conference sessions to the user.

In one example embodiment, a user may select a conference meeting from the presented scheduled conference sessions, may join a conference meeting (conference session) of another user, or may start an ad hoc conference meeting using an instant conference code (operation 228). An instant conference code is a conference code for initiating an unscheduled conference call session. In one example embodiment, the instant conference code is generated by the VMR management server 140.

In response to the user selecting a conference session, the conference processor 116 sends the information used to initiate the conference meeting to the conferencing device 136 (operation 238), and the conferencing device 136 may forward instructions for the conference session to a media application executing on the VMR management server 140 (operation 246). The VMR management server 140 assumes management of the conference call and establishes the conference call on the MCU server 144. The media application receives the conference code from the conferencing device 136 and cross references the conference code to a user name in a local database (operation 248). The media application assigns a VMR to an MCU blade on the MCU server 144 and configures the MCU blade accordingly (operation 250). In response to receiving the assignment from the media application, the MCU server 144 establishes conference communications for a specified conference session (operation 252) and sends conference communications set-up information back to the media application (operation 254).

The MCU server 144 may then auto-dial to a hosted audio bridge (operation 256). The hosted audio bridge may be implemented on the telecommunications PBX 148 and provides connectivity between one or more user telecommunications devices 160 and the ongoing conference call. Each participating telecommunications devices 160 may join the conference session via the audio bridge (operation 268).

The media application sends a call set-up request to the conferencing device 136 that initiated the conference session and directs the conferencing device 136 to the assigned MCU blade for the media flow (operation 260). In addition, additional participants in the conference meeting may be sent the call set-up information directing the corresponding conferencing device(s) 136 to their assigned MCU blade (operation 262). Each participating conferencing device 136 may connect to the VMR via the MCU blade and the conference meeting may commence (operation 264).

FIG. 3 is a block diagram of an example apparatus 300 for initiating, conducting, and terminating a conference session, in accordance with an example embodiment. The apparatus 300 is shown to include a processing system 302 that may be implemented on a client or other processing device that includes an operating system 304 for executing software instructions. The apparatus 300 may be used to implement the conference processor 116.

In accordance with an example embodiment, the apparatus 300 may include a user interface module 306, a card reader interface module 310, a conference device interface module 314, and a conference session processing module 318. In accordance with an example embodiment, the apparatus 300 may further include a storage interface 322 for accessing, for example, configuration information for a conference call.

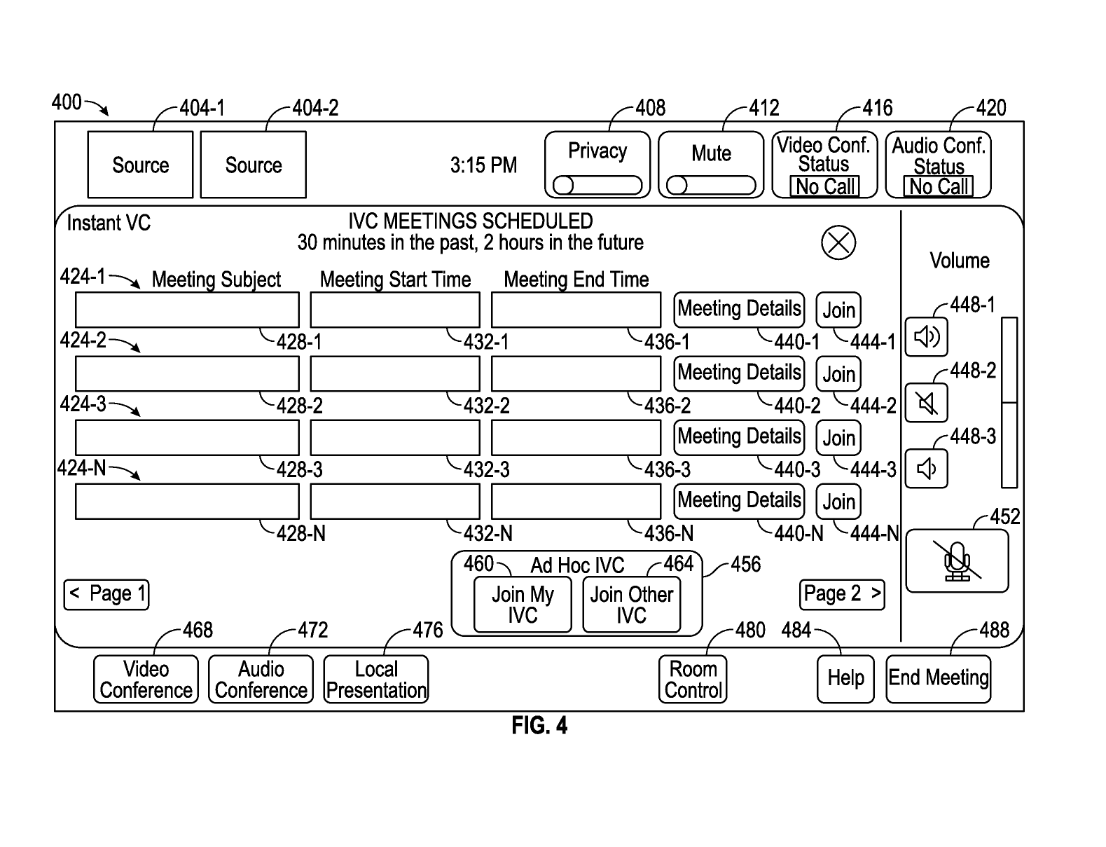

The user interface module 306 enables a user to access a scheduled conference session, join an existing conference session, or initiate an unscheduled conference session (known herein as an instant conference session). The user interface module 306 generates a user interface for a user, as described more fully below in conjunction with FIG. 4.

The card reader interface module 310 obtains input data from the card reader 112. For example, the card reader interface module 310 may obtain information read from an employee badge via the card reader 112 in order to identify a scheduled conference session.

The conference device interface module 314 exchanges information with the conferencing device 136. For example, the conference device interface module 314 may send information used to initiate the conference session to the conferencing device 136. The conference session processing module 318 manages the initiation, execution, and termination of a conference session, as described more fully in conjunction with FIGS. 2A, 2B, and 4. The conference session processing module 318 may scan calendar entries of a user's calendar in search of meetings containing conference information and may present relevant scheduled conference call meetings to a user.

FIG. 4 is a representation of an example user interface 400 for initiating, conducting, and terminating a conference call, in accordance with an example embodiment. In one example embodiment, the user interface 400 may be utilized by the user device 104 to enable a user to conduct a conference call.

The user interface 400 may present one or more conference meetings 424-1, . . . , 424-N (hereinafter conference meetings 424) via the user device 104. For each conference meeting 424, the user interface 400 may display a meeting subject 428-1, . . . , 428-N (hereinafter meeting subjects 428), a meeting start time 432-1, . . . , 432-N (hereinafter meeting start times 432), and a meeting end time 436-1, . . . , 436-N (hereinafter meeting end times 436). In addition, the user interface 400 may display meeting details, such as a list of attendees (not shown), in response to a selection of a meeting details icon 440-1, . . . , 440-N (hereinafter meeting details icons 440). A user may join a meeting by selecting a corresponding join icon 444-1, . . . , 444-N (hereinafter join icons 444).

Once the conference call is established, the user may adjust an audio volume using audio volume icons 448-1, . . . , 448-3 and may mute the transmitted audio by selecting a mute icon 452 or 412. During the conference meeting, the status of a video conference may be indicated by a video conference status indicator 416, and the status of an audio conference may be indicated by an audio conference status indicator 420. A user may terminate a conference meeting by selecting an end meeting icon 488.

In one example embodiment, a user may initiate an unscheduled conference session via an ad hoc IVC interface 456. A “Join My IVC” icon 460 may be selected to join an unscheduled conference session initiated by the same user, and a “Join Other IVC” icon 464 may be selected to join an unscheduled conference call session initiated by another user.

In one example embodiment, different user interfaces may be selected based on the type of conference call session. For example, a video conference tab 468 may be selected to access the user interface 400 shown in FIG. 4, and an audio conference tab 472 may be selected to access a user interface directed to audio only conference call sessions (not shown). In one example embodiment, a local presentation tab 476 may be selected, for example, to access a presentation to be shared with users participating in a conference call session.

In one example embodiment, a help icon 484 may be selected by a user to access help services, and a room control icon 480 may be selected to access room control features, such as a remote control interface for room lighting. In one example embodiment, source icons 404-1 and 404-2 may be selected to select a particular source of content, including video, audio, and graphical content. For example, source icons 404-1 and 404-2 may be associated with different cameras in a conference room. In one example embodiment, a privacy icon 408 may be selected to block unauthorized participants from participating in the conference session.

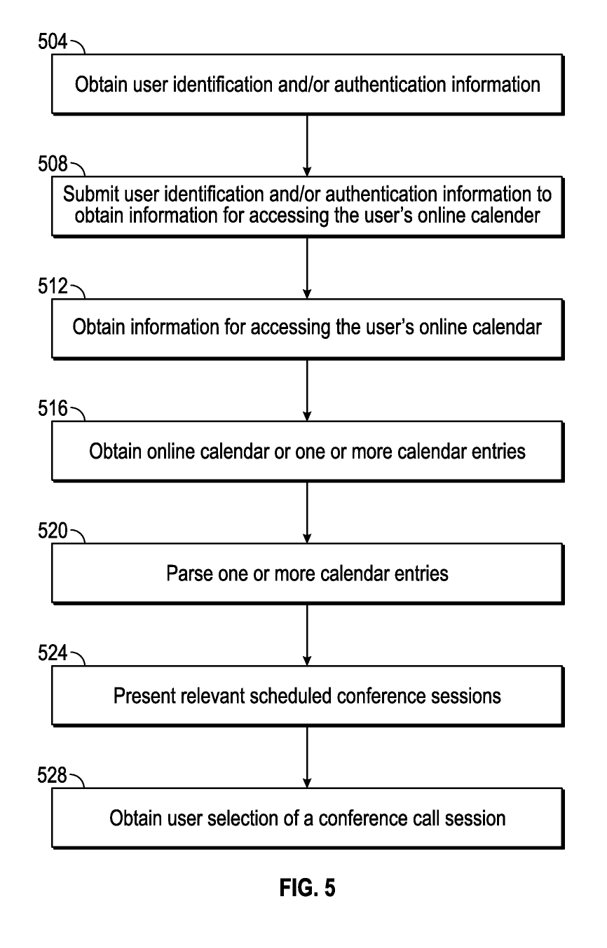

FIG. 5 is a flowchart for an example method 500 for initiating, conducting, and terminating a conference session, in accordance with an example embodiment. In one example embodiment, one or more of the operations of the method 500 may be performed by the conference session processing module 318.

In one example embodiment, identification and/or authentication information from a user may be obtained (operation 504). For example, identification information may be obtained from the card reader 112 and may comprise, for example, an employee identification number. The identification information may comprise an RFID code read from an employee identification card. In one example embodiment, a user may use biometrics (e.g., a fingerprint), information (e.g., a password), a device (e.g., an RFID tag), and the like to present the identification information.

The identification and/or authentication information may be submitted to, for example, the IVC server 128 to obtain information for accessing the user's online calendar (operation 508). For example, the IVC server 128 may match an RFID code or employee identification number to a user name, an electronic mail address, and the like. The IVC server 128 may interact with the security database 132 to authenticate the user and determine information for accessing the user's online calendar.

The information for accessing the user's online calendar may be obtained from, for example, the IVC server 128 (operation 512). For example, the user name and/or the electronic mail address of the user may be obtained from the IVC server 128.

The information for accessing the user's online calendar may be submitted to the calendar lookup server 124 to obtain the user's online calendar. For example, the user name and/or the electronic mail address of the user may be submitted to the calendar lookup server 124. The calendar lookup server 124 may then interact with the mail server 120 to obtain the user's calendar stored on the mail server 120. The online calendar, including conference codes associated with scheduled conference call sessions, or one or more calendar entries, including conference codes associated with scheduled conference call sessions, may be obtained from the calendar lookup server 124 (operation 516).

One or more calendar entries of the user may be parsed in search of meetings containing conference information (operation 520). For example, a custom script may search for a conference code in the body of each calendar entry. The search may be limited to a particular time period. For example, the conference processor 116 may limit the search to 30 minutes in the past and 90 minutes in the future of the present time. The relevant scheduled conference sessions may be presented to the user (operation 524).

Instructions regarding the conference session may then be obtained from the user (operation 528). For example, a request to initiate a selected conference session from the presented scheduled conference sessions, a request to join a conference meeting (conference session) of another user, or a request to initiate an ad hoc conference meeting using an instant conference code may be obtained from the user.

As described above, information to initiate or join a conference session may be sent to, for example, the conferencing device 136. The conferencing device 136 may forward instructions for the conference call session to the media application executing on the VMR management server 140. The VMR management server 140 establishes the conference session on the MCU server 144.

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

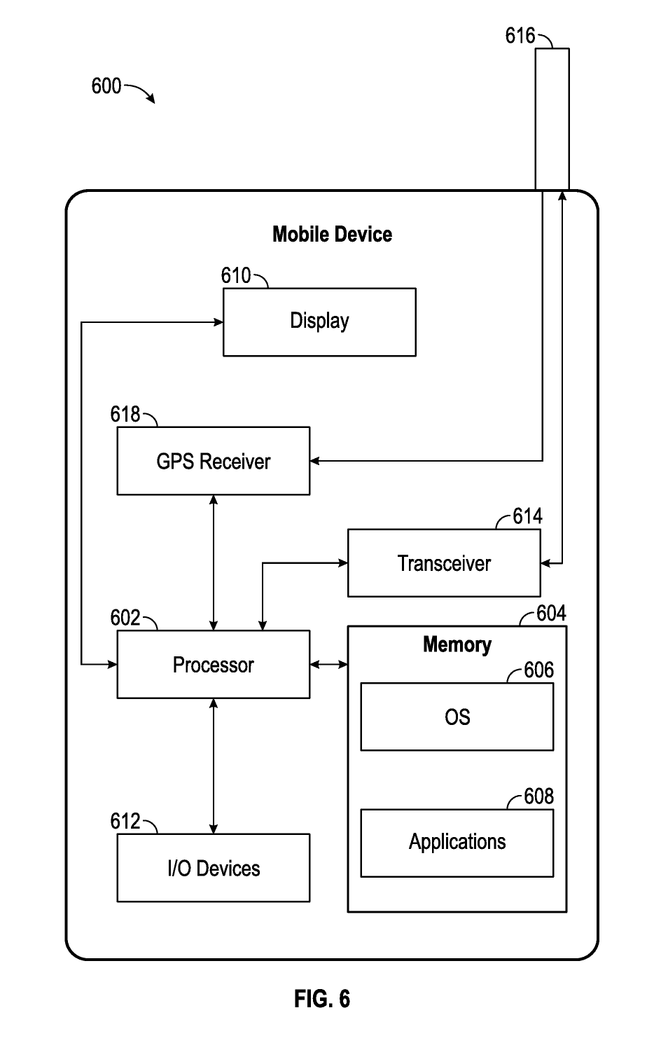

FIG. 6 is a block diagram illustrating a mobile device 600, according to an example embodiment. The mobile device 600 can include a processor 602. The processor 602 can be any of a variety of different types of commercially available processors suitable for mobile devices 600 (for example, an XScale architecture microprocessor, a Microprocessor without Interlocked Pipeline Stages (MIPS) architecture processor, or another type of processor). A memory 604, such as a random access memory (RAM), a flash memory, or another type of memory, is typically accessible to the processor 602. The memory 604 can be adapted to store an operating system (OS) 606, as well as applications 608, such as a mobile location enabled application that can provide location based services (LBSs) to a user. The processor 602 can be coupled, either directly or via appropriate intermediary hardware, to a display 610 and to one or more input/output (I/O) devices 612, such as a keypad, a touch panel sensor, and a microphone. Similarly, in some embodiments, the processor 602 can be coupled to a transceiver 614 that interfaces with an antenna 616. The transceiver 614 can be configured to both transmit and receive cellular network signals, wireless data signals, or other types of signals via the antenna 616, depending on the nature of the mobile device 600. Further, in some configurations, a GPS receiver 818 can also make use of the antenna 616 to receive GPS signals.

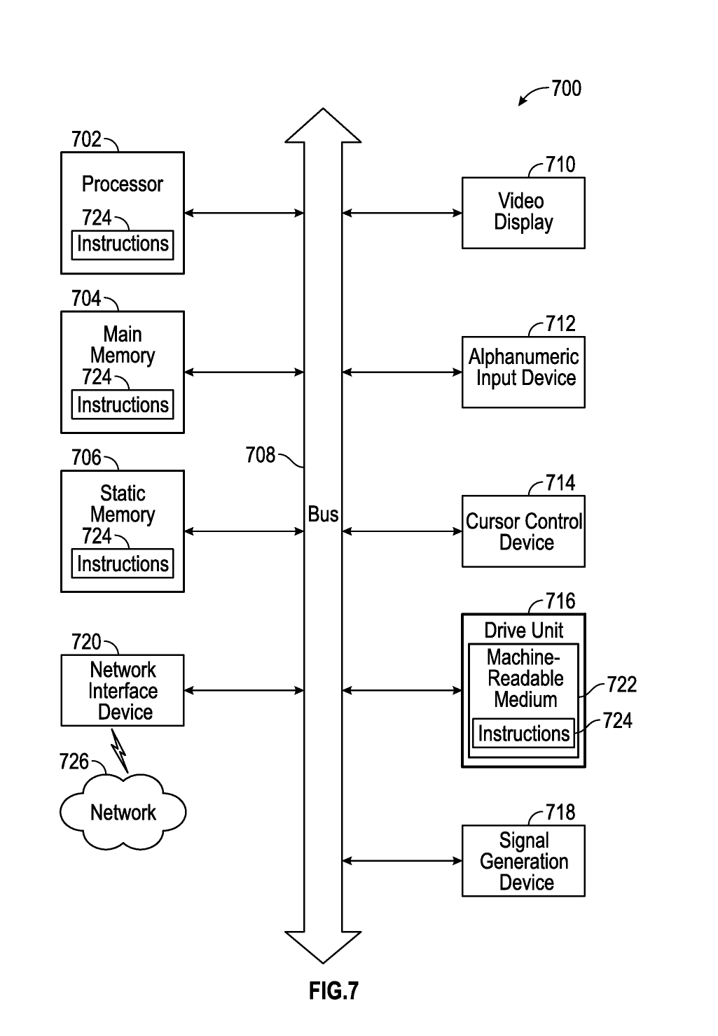

FIG. 7 is a block diagram of a machine in the form of an example computer system 700 within which instructions may be executed for causing the machine to perform any one or more of the methodologies discussed herein. In one example embodiment, the machine may be the example apparatus 300 of FIG. 3 for initiating, conducting, and terminating a conference call. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a PDA, a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a drive unit 716, a signal generation device 718 (e.g., a speaker), and a network interface device 720.

The drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, with the main memory 704 and the processor 702 also constituting machine-readable media. The instructions 724 may also reside within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more data structures or instructions 724. The term “machine-readable medium” shall also be taken to include any tangible medium that is capable of storing, encoding, or carrying the instructions 724 for execution by the machine and that cause the machine to perform any one or more of the methodologies disclosed herein, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., hypertext transfer protocol (HTTP)). Examples of communication networks include a LAN, a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 724 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system to initiate and conduct a conference call, the system comprising:
a conference session processing module comprising one or more processors, the conference session processing module configured to:
obtain identification information of a user;
determine one or more of an electronic mail address and a user name of the user based on the identification information;
access at least a first portion of an online calendar of the user based on one or more of the electronic mail address and the user name;
parse at least a second portion of the online calendar to identify one or more scheduled conference sessions; and
initiate a conference session based on a user selection; and
a user interface module configured to:
present one or more of the scheduled conference sessions; and
obtain the user selection of one of the one or more scheduled conference sessions.

2. The system of claim 1, wherein the identification information of the user is obtained from a card reader.

3. The system of claim 1, wherein the user is identified by matching a radio frequency code associated with the user to one or more of the electronic mail address and the user name.

4. The system of claim 1, the conference session processing module further configured to generate a personal conference signature for scheduling the conference session and generate invitations for one or more participants of the conference session.

5. The system of claim 1, wherein the one or more scheduled conference sessions are identified by searching for a conference code in a body of a calendar entry.

6. The system of claim 5, the conference session processing module configured to obtain a cross reference of the conference code to the user name to establish the conference session.

7. The system of claim 1, wherein the parsing operation is performed only on calendar entries occurring within a defined time window of a current time.

8. A method to initiate and conduct a conference call, the method comprising:
obtaining identification information of a user;
determining one or more of an electronic mail address and a user name of the user based on the identification information;
accessing at least a first portion of an online calendar of the user based on one or more of the electronic mail address and the user name;
parsing at least a second portion of the online calendar to identify one or more scheduled conference sessions;
presenting one or more of the scheduled conference sessions;
obtaining a user selection of one of the one or more scheduled conference sessions; and
initiating a conference session based on the user selection.

9. The method of claim 8, wherein the identification information of the user is obtained from a card reader.

10. The method of claim 8, wherein the user is identified by matching a radio frequency code associated with the user to one or more of the electronic mail address and the user name.

11. The method of claim 8, further comprising generating a personal conference signature for scheduling the conference session and generating invitations for one or more participants of the conference session.

12. The method of claim 8, wherein the one or more scheduled conference sessions are identified by searching for a conference code in a body of a calendar entry.

13. The method of claim 12, further comprising cross referencing the conference code to the user name to establish the conference session.

14. The method of claim 8, wherein the parsing operation is performed only on calendar entries occurring within a defined time window of a current time.

15. A non-transitory computer-readable medium embodying instructions that, when executed by a processor, perform operations comprising:
obtaining identification information of a user;
determining one or more of an electronic mail address and a user name of the user based on the identification information;
accessing at least a first portion of an online calendar of the user based on one or more of the electronic mail address and the user name;
parsing at least a second portion of the online calendar to identify one or more scheduled conference sessions;
presenting one or more of the scheduled conference sessions;
obtaining a user selection of one of the one or more scheduled conference sessions; and
initiating a conference session based on the user selection.

16. The non-transitory computer-readable medium of claim 15, wherein the identification information of the user is obtained from a card reader.

17. The non-transitory computer-readable medium of claim 15, wherein the user is identified by matching a radio frequency code associated with the user to one or more of the electronic mail address and the user name.

18. The non-transitory computer-readable medium of claim 15, further comprising instructions that, when executed by a processor, perform operations comprising:
generating a personal conference signature for scheduling the conference session; and
generating invitations for one or more participants of the conference session.

19. The non-transitory computer-readable medium of claim 15, wherein the one or more scheduled conference sessions are identified by searching for a conference code in a body of a calendar entry.

20. The non-transitory computer-readable medium of claim 19, further comprising further comprising instructions that, when executed by a processor, perform operations comprising cross referencing the conference code to the user name to establish the conference session.
